(19) United States
(12) Patent Application Publication
(10) Pub. No.: US 2026/0106270 A1
(43) Pub. Date: Apr. 16, 2026

(54) SECONDARY BATTERY MODULE, METHOD OF MANUFACTURING THE SAME, AND INSULATION UNIT FOR SECONDARY BATTERY MODULE

(71) Applicant: Samsung SDI Co., Ltd., Yongin-si (KR)

(72) Inventor: Kyuyul Han, Yongin-si (KR)

(73) Assignee: Samsung SDI Co., Ltd., Yongin-si (KR)

(21) Appl. No.: 19/314,670

(22) Filed: Aug. 29, 2025

(30) Foreign Application Priority Data
Oct. 16, 2024 (KR) 10-2024-0141622

(51) Int. Cl. H01M 10/658; H01M 10/647; H01M 50/209; H01M 50/24; H01M 50/293

(52) U.S. Cl. CPC H01M 10/658; H01M 10/647; H01M 50/209; H01M 50/24; H01M 50/293

(57) ABSTRACT

The present disclosure relates to a secondary battery module and a method of manufacturing the same. A secondary battery module may include a module case that provides an internal space, a plurality of battery cells disposed in the module case, and a plurality of insulation units that are interposed between the battery cells and maintain a distance between the battery cells, wherein each of the insulation units includes a variable housing that accommodates a filler injected from the outside and expands due to a pressure of the filler to increase the distance between the battery cells or shrinks by receiving a pressure of the battery cells, and a filler passage provided at one side of the variable housing to allow the filler to pass therethrough.

### CROSS-REFERENCE TO RELATED APPLICATIONS

This present application claims priority to and the benefit under 35 U.S.C. §119(a)-(d) of Korean Patent Application No. 10-2024-0141622, filed on Oct. 16, 2024, in the Korean Intellectual Property Office, the entire disclosure of which is incorporated herein by reference.

### FIELD

The present disclosure relates to a secondary battery module in which an insulation member is applied between cells forming the secondary battery module, a method of manufacturing the same, and an insulation unit for a secondary battery module.

### BACKGROUND

Secondary batteries are batteries that can be charged and discharged, unlike primary batteries that cannot be recharged. In general, a secondary battery includes an electrode assembly formed of electrode plates of positive and negative electrodes, a case that accommodates the electrode assembly, an electrode terminal connected to the electrode assembly, a vent for degassing gas generated inside the case, and the like.

The above information disclosed in this Background section is for enhancement of understanding of the background of the present disclosure, and therefore, it may contain information that does not constitute a related (or prior) art.

### SUMMARY

The present disclosure is directed to providing a secondary battery module, a method of manufacturing a secondary battery module, and an insulation unit for a secondary battery module, which are capable of securing a constant length of a cell stack and preventing pressing defects in a process of manufacturing a module by adjusting a gap between cells to cancel thickness distribution even when the thickness distribution of the cells forming a secondary battery module occurs.

A secondary battery module according to some aspects of the present disclosure may include a module case that provides an internal space, a plurality of battery cells disposed in the module case, and a plurality of insulation units that are interposed between the battery cells and maintain a distance between the battery cells, wherein each of the insulation units includes a variable housing that accommodates a filler injected from the outside and expands due to a pressure of the filler to increase the distance between the battery cells or shrinks by receiving a pressure of the battery cells, and a filler passage provided at one side of the variable housing to allow the filler to pass therethrough.

In some embodiments, a plurality of pressing plates, which move away from one another and transfer the pressure to the plurality of battery cells as an internal pressure of the variable housing increases, are installed inside the variable housing.

In some embodiments, the variable housing is configured to melt due to heat generated inside the module case and rupture due to an action of the internal pressure of the variable housing.

In some embodiments, a through hole, which allows the filler inside the variable housing to pass therethrough when the variable housing ruptures, is formed in the plurality of pressing plates.

In some embodiments, the plurality of pressing plates face one another in the variable housing, and a plurality of cross-protrusions, which are in surface contact with one another in a crossing state and slide when the variable housing expands and shrinks, are further formed on surfaces facing one another of the plurality of pressing plates.

In some embodiments, the filler passage includes an injection port that guides the filler provided from the outside region to inside of the variable housing.

In some embodiments, the filler passage further includes a vent port that discharges the filler inside the variable housing to the outside region of the variable housing when a battery cell of the plurality of battery cells expands.

In some embodiments, the filler passage includes a two-way port that guides the filler provided from the outside region to inside of the variable housing and discharges the filler inside the variable housing to the outside region of the variable housing when a battery cell of the plurality of battery cells expands.

In some embodiments, the filler includes at least one of air, an aerofoam, and an extinguishing agent.

In addition, a method of manufacturing a secondary battery module according to some aspects of the present disclosure may include a stacking operation of stacking an insulation unit that suppresses heat transfer between a plurality of battery cells to be accommodated inside a module case and allows a thickness thereof to be adjusted, wherein the insulation unit is stacked to be interposed between adjacent battery cells, a jig mounting operation of arranging a jig outside an outermost battery cell of a stack, a size adjusting operation of adjusting the thickness of the insulation unit and matching a total thickness of the stack with a length of an internal space of the module case, a seating operation of installing the stack whose size adjustment is completed in the module case, and a packaging operation of packaging the module case.

In some embodiments, the insulation unit accommodates a filler injected from the outside and is configured to expand due to a pressure of the filler to increase a distance between the battery cells or to shrink by receiving a pressure of the battery cells, and the size adjusting operation is a process of press-fitting the filler into the insulation unit to increase the total thickness of the stack or pressing the stack using a jig to decrease the total thickness.

In addition, an insulation unit for a secondary battery module according to some aspects of the present disclosure may include a variable housing that accommodates a filler injected from the outside and expands due to a pressure of the filler to increase a distance between battery cells or shrinks by receiving a pressure of the battery cells after being interposed between the plurality of battery cells to be mounted in a module case for a secondary battery module, and a filler passage provided at one side of the variable housing to allow the filler to pass therethrough.

In some embodiments, a plurality of pressing plates, which move away from one another and transfer the pressure to the battery cells as an internal pressure of the variable housing increases, are installed inside the variable housing.

In some embodiments, the variable housing is configured to melt due to heat generated inside the module case and rupture due to an action of the internal pressure of the variable housing.

In some embodiments, a through hole, which allows the filler inside the variable housing to pass therethrough when the variable housing ruptures, is formed in the plurality of pressing plates.

In some embodiments, the plurality of pressing plates face one another in the variable housing, and a plurality of cross-protrusions, which are in surface contact with one another in a crossing state and slide when the variable housing expands and shrinks, are further formed on surfaces facing one another of the plurality of pressing plates.

In some embodiments, the filler passage includes an injection port that guides the filler provided from the outside region to inside of the variable housing.

In some embodiments, the filler passage further includes a vent port that discharges the filler inside the variable housing to the outside region of the variable housing when a battery cell of the plurality of battery cells expands.

In some embodiments, the filler passage includes a two-way port that guides the filler provided from the outside region to inside of the variable housing and discharges the filler inside the variable housing to the outside region of the variable housing when a battery cell of the plurality of battery cells expands.

In some embodiments, the filler includes at least one of air, an aerofoam, and an extinguishing agent.

Aspects and features of the present disclosure are not limited to those described herein, and other aspects and features not specifically mentioned herein will be clearly understood by those skilled in the art from the description of the present disclosure herein.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view illustrating a prismatic secondary battery cell;

FIG. 2 is a plan view illustrating a basic configuration of a secondary battery module to which an insulation unit according to some embodiments of the present disclosure is applied;

FIG. 3 is an exemplary view of a secondary battery pack including the secondary battery module of FIG. 2;

FIG. 4 is a conceptual diagram illustrating a secondary battery pack installed in a vehicle;

FIG. 5 is a cross-sectional view for showing a configuration of the insulation unit for a secondary battery module according to some embodiments of the present disclosure;

FIG. 6 is a view illustrating a modified example of the insulation unit illustrated in FIG. 5;

FIG. 7 is a view illustrating a state in which a filler is ejected when a housing of the insulation unit of FIG. 6 ruptures;

FIGS. 8 and 9 are views illustrating another modified example of the insulation unit of FIG. 5;

FIGS. 10 and 11 are views for showing a configuration and operation of an injection port applicable to the insulation unit according to some embodiments of the present disclosure;

FIGS. 12 and 13 are views for showing a configuration and operation of a vent port applicable to the insulation unit according to some embodiments of the present disclosure;

FIGS. 14 to 16 are views for showing a configuration and operation of a two-way port applicable to the insulation unit according to some embodiments of the present disclosure;

FIG. 17 is a flowchart illustrating a method of manufacturing a secondary battery module according to some embodiments of the present disclosure; and

FIGS. 18A-18E are schematic views illustrating a method of manufacturing a secondary battery module according to some embodiments of the present disclosure.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her technology in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average. Throughout the specification, unless otherwise stated, each element may be singular or plural.

Arranging an arbitrary element “above (or below)” or “on (or under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to one another, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

Recently, secondary batteries have been used for motor driving and power storage in hybrid vehicles, electric vehicles, and the like and are becoming larger in capacity. In large-capacity batteries, there is a particularly high demand for safety, and for example, in the case of electric vehicles, there may be accidents in which an external object damages a battery case and permeates or penetrates the electrode assembly therein. In this configuration, the negative and positive electrodes of the electrode assembly can come into contact and cause a very large short-circuit current to flow, thereby causing overheating, thermal runaway, or explosion of the battery.

Meanwhile, in some embodiments, a secondary battery module has a case, a plurality of battery cells, and an insulator. The insulator can be mounted between the cells and can function to delay heat transfer between the cells and insulate the cells. However, since conventional insulators have a fixed thickness, the inventor has identified a problem in that the length of the entire cell stack changes when thickness distribution of the cells occurs. Accordingly, to constantly adjust the length of the cell stack, a pressing force is applied from both sides of the stack, and pressing conditions have a set range. When the length is not correct even when a pressing force in the pressure range is applied, the corresponding module is considered defective.

The inventor has developed a secondary battery module, a method of manufacturing a secondary battery module, and an insulation unit for a secondary battery module, which are capable of securing a constant length of a cell stack and preventing pressing defects in a process of manufacturing a module by adjusting a gap between cells to cancel or reduce thickness distribution even when the thickness distribution of the cells forming a secondary battery module occurs, as described further herein.

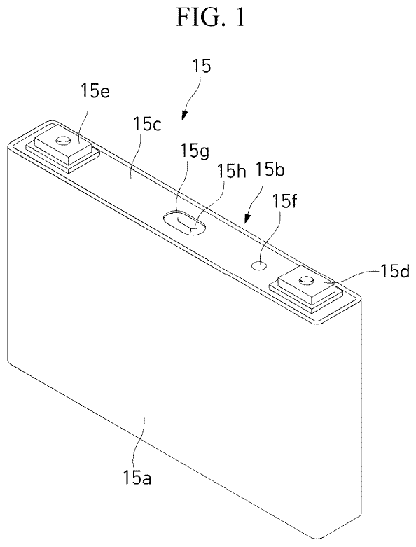

FIG. 1 is a top perspective view illustrating an exterior of a prismatic battery cell 15.

A case 15a forms the overall appearance of the prismatic battery and may be formed of a conductive metal such as aluminum, an aluminum alloy, or nickel-plated steel. In addition, the case 15a may provide a space for accommodating an electrode assembly therein.

A cap assembly 15b may include a cap plate 15c that covers the opening of the case 15a. In some examples, the case 15a and the cap plate 15c may be made of a conductive material. Here, a first terminal 15d and a second terminal 15e may be electrically connected to respective positive and negative (or negative and positive) electrodes inside the case, and may be installed to protrude outward through the cap plate 15c.

An electrolyte inlet 15f may be formed in the cap plate 15c, a gas discharge hole 15g may be opened, and a vent, e.g., a gas discharge device 15h may be connected to the gas discharge hole 15g. The gas discharge device 15h can be opened by gas generated inside the battery and can perform a degassing function.

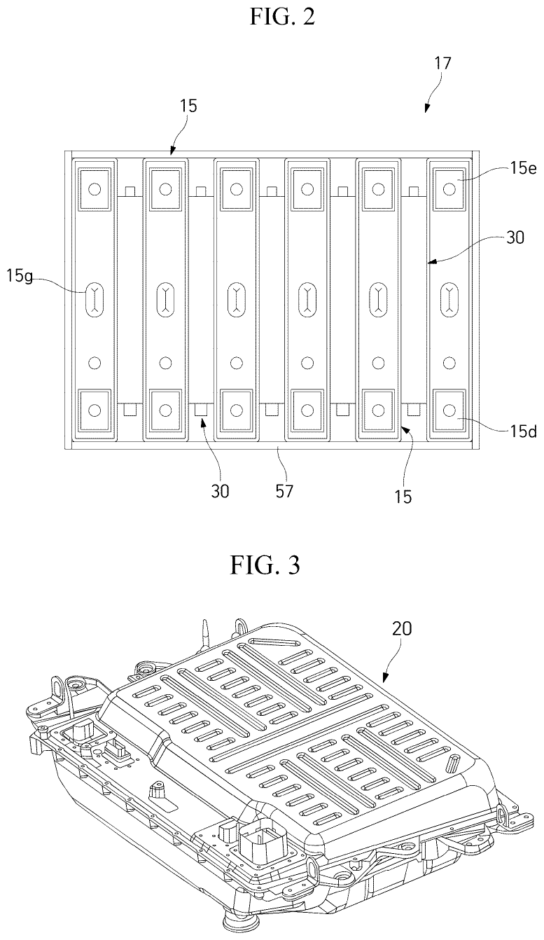

FIG. 2 is a schematic plan view illustrating a basic configuration of a secondary battery module to which an insulation unit according to some embodiments of the present disclosure is applied.

As illustrated, a secondary battery module 17 according to the present embodiment may include a module case 57, a plurality of battery cells 15, and an insulation unit 30.

The module case 57 may provide an internal space having a predetermined volume. The module case 57 may be a housing of the secondary battery module 17 and may accommodate the battery cells 15 and the insulation unit 30 therein. Wiring including a busbar, a control module, and the like may be applied to the module case 57.

The battery cells 15 may remain separated by the insulation unit 30. The insulation unit 30 blocks heat transfer between the battery cells 15 and performs electrical insulation. As described with reference to FIG. 1, the battery cells 15 are prismatic batteries and may be separated by the insulation unit 30.

The insulation unit 30 may be interposed between adjacent battery cells 15 and may maintain the gap between the battery cells. A thickness of the insulation unit 30 is variable. The thickness of the insulation unit 30 may be adjusted by press-fitting a filler described below. This will be described herein.

FIG. 3 is an example view of a secondary battery pack 20 formed to apply the secondary battery module shown in FIG. 2 to an actual product (e.g., a vehicle). The battery pack may include an assembly to which individual batteries are electrically connected and a pack housing accommodating the same. In FIG. 3, for simplicity of illustration, components including a bus bar, a cooling unit, external terminals for electrically connecting batteries, etc., are not shown.

The secondary battery pack may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle but is not limited thereto.

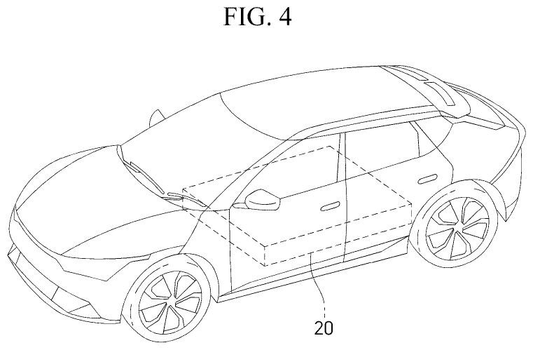

FIG. 4 is a view for showing a vehicle including the secondary battery pack illustrated in FIG. 3. FIG. 4 shows a vehicle that includes the battery pack 20 shown in FIG. 3 on the lower body thereof. The vehicle may operate by (e.g., may be powered by) receiving power from the battery pack 20.

The materials that can be used in the herein-described secondary battery are as follows.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0<b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0<c<0.5, 0<c<2); LiₐN_{1-b-c}Mn_{b}X_{c}O₂₋₆₀ D_{α} (0.90≤a≤1.8, 0≤b≤0.5, 0<α<0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001<b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001<b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a secondary battery may include a current collector and a positive electrode active material layer formed on the current collector. The positive electrode active material layer may include a positive electrode active material and may further include a binder and/or a conductive material.

The content of the positive electrode active material may be in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particles and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material. A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent can act as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O3, SiO₂, TiO₂, SnO₂, CeO₂, MgO, NiO, CaO, GaO, ZnO, ZrO₂, Y₂O3, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on one another (e.g., each other).

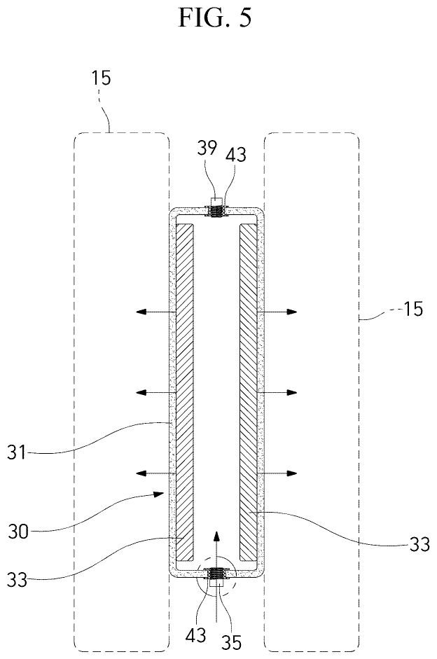

FIG. 5 is a cross-sectional view for showing a basic configuration of the insulation unit 30 for a secondary battery module according to some embodiments of the present disclosure.

As illustrated, the insulation unit 30 for a secondary battery module according to the present embodiments may include a variable housing 31 and a filler passage.

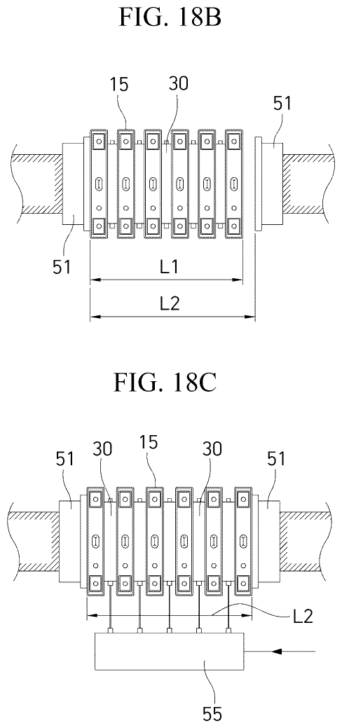

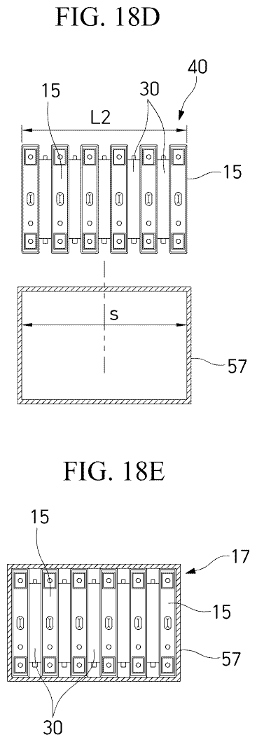

The insulation unit 30 may be mounted between adjacent battery cells 15 and adjust a gap between the battery cells 15. Accordingly, a total thickness of a stack 40 (see e.g., FIG. 18D) including the plurality of battery cells 15 may be adjusted so that a total thickness L1 of the stack 40 matches a length of an internal space S (see e.g., FIG. 18D) of the module case 57.

The variable housing 31 may be a sealing member that accommodates a filler injected from the outside (e.g., an outside region) and may expand due to a pressure of the filler to widen the gap between the battery cells 15 or shrink by receiving the pressure of the battery cells 15. Here, the pressure of the battery cells may be a pressure generated when the battery cells swell. When the battery cells expand due to deterioration caused by the use of the module, the insulation unit 30 may absorb a change in thickness of the battery cells.

In addition, the variable housing 31 may melt and rupture due to heat in the circumstance of a fire or overheating inside the module case 57. That is, the variable housing 31 may melt due to the heat generated inside the module case and rupture due to internal pressure of the variable housing. For example, a hole may be formed due to heat. A reason why the variable housing 31 may be designed to rupture in this way is that when a fire extinguishing agent is injected into the variable housing 31 as a filler, the fire extinguishing agent is injected through the ruptured hole. By utilizing the fire extinguishing agent as a filler, it is possible to quickly respond to a battery thermal runaway situation.

The variable housing 31 may be formed of a flexible synthetic resin. In addition, the filler injected into the variable housing 31 may be at least one of air, an aerofoam, or a fire extinguishing agent.

Meanwhile, the filler passage may function as a valve that allows a filler to pass therethrough. The filler passage in the present embodiments may be an injection port 35 and a vent port 39, or a two-way port 37 (see e.g., FIG. 14). The injection port 35 and the vent port 39 may be formed in a pair and used together in the variable housing 31. In addition, the two-way port 37 allows the filler (to go) in both directions, and thus may be used alone.

The insulation unit 30 illustrated in FIGS. 5 to 9 shows a state in which the injection port 35 and the vent port 39 are applied. However, in other embodiments (e.g., see FIGS. 14 to 16), the two-way port 37 may be mounted instead of the injection port 35 and the vent port 39.

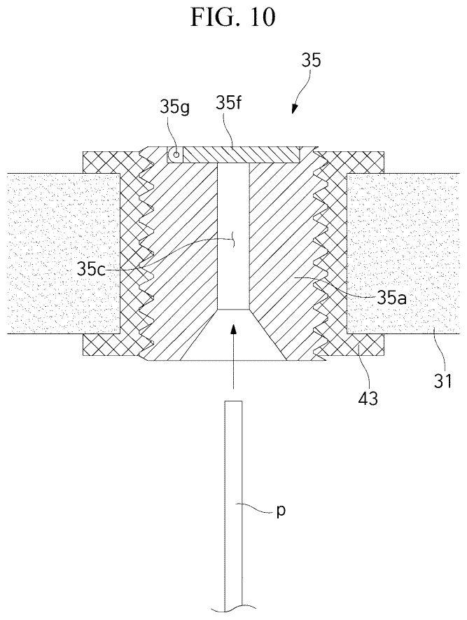

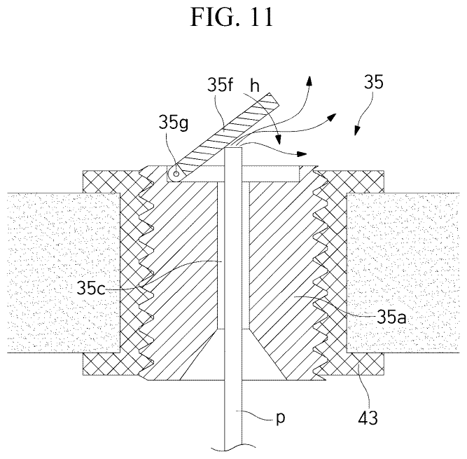

The injection port 35 can function to guide the filler provided from the outside to the inside of the variable housing 31. A configuration of the injection port 35 may be implemented in any of various ways and may have the configurations illustrated in FIGS. 10 and 11.

As illustrated in FIG. 5, the injection port 35 may be installed on a lower portion of the variable housing 31 in the drawing. In addition, a fixing nut 43 may be installed on the variable housing 31 so that the injection port 35 may be mounted. The fixing nut 43 is a component fixed to the variable housing 31 and may have a female screw thread on an inner circumferential surface thereof. The fixing nut 43 may be fixedly adhered to the variable housing 31. The injection port 35 may be screw-coupled to the fixing nut 43. The injection port 35 may be separated from the fixing nut 43. The injection port 35 may be replaced.

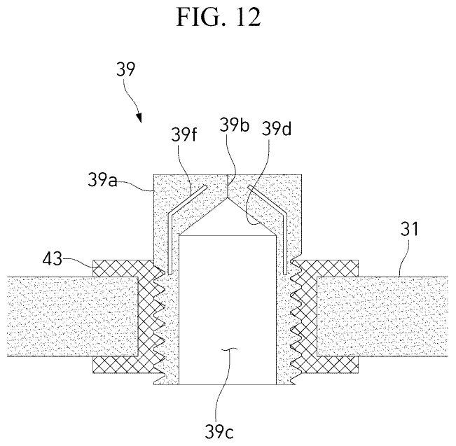

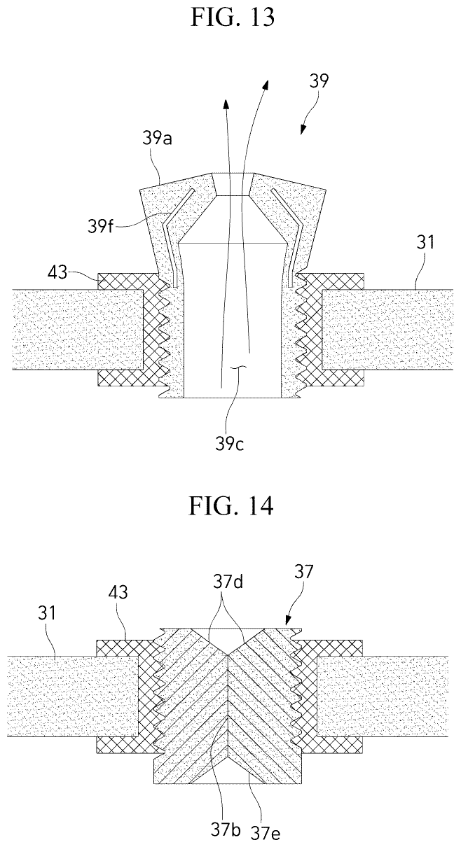

The vent port 39 may be installed at the top of the variable housing 31 in the drawing. The vent port 39 may absorb a change in thickness of the battery cells 15 by discharging the filler inside the variable housing 31 to the outside of the variable housing when the left and right battery cells 15 expand. The variable housing 31 shrinks as much as the battery cells 15 expand. A configuration of the vent port 39 may also be implemented in any of various ways as long as it may perform such a role. For example, the vent port 39 may have configurations of FIGS. 12 and 13 described herein. The vent port 39 may also be mounted by the fixing nut 43. The vent port 39 may also be replaced.

Meanwhile, pressing plates 33 may be installed inside the variable housing 31. The pressing plates 33 may be pushed away from one another as the internal pressure of the variable housing increases and may transfer the pressure to the battery cells 15. That is, expansion strength of the variable housing 31 is transferred to the battery cells 15. The adjacent battery cells 15 may be spread by receiving the pressure of the pressing plates 33.

The pressing plates 33 may have plate shapes having a predetermined thickness. The pressing plates 33 may be formed of a heat-resistant synthetic resin. By utilizing the pressing plates 33, the expansion strength of the variable housing 31 can be effectively transferred to the battery cells 15. In addition, even when the insulation unit 30 shrinks due to the expansion of the battery cells 15, a separation distance of at least the thickness of two pressing plates 33 can be secured.

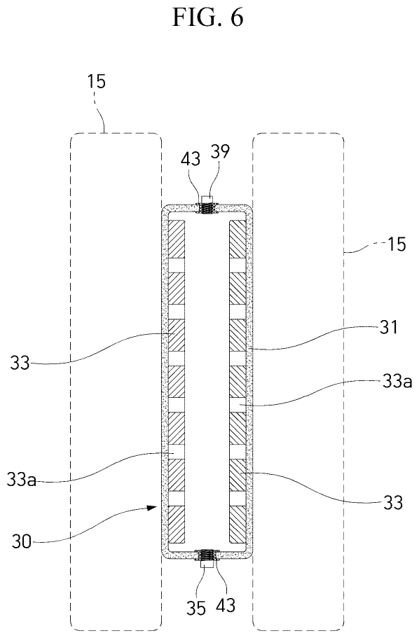

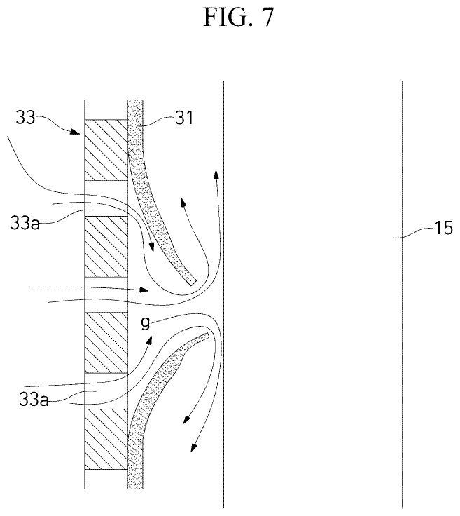

FIG. 6 is a view illustrating a modified example of the insulation unit 30 illustrated in FIG. 5. FIG. 7 is a view illustrating a state in which the filler is ejected when the housing of the insulation unit of FIG. 6 ruptures.

As illustrated, a plurality of through holes 33a may be formed in the pressing plates 33 at both sides of the insulation unit 30. The through holes 33a may be holes through which the filler inside the variable housing 31 passes when the variable housing 31 between the pressure plates 33 and the battery cells 15 ruptures. By utilizing the through holes 33a, the filler may pass through the through holes 33a in a direction of arrow g and then may be in direct contact with the battery cells 15. The filler at this time may be an extinguishing agent.

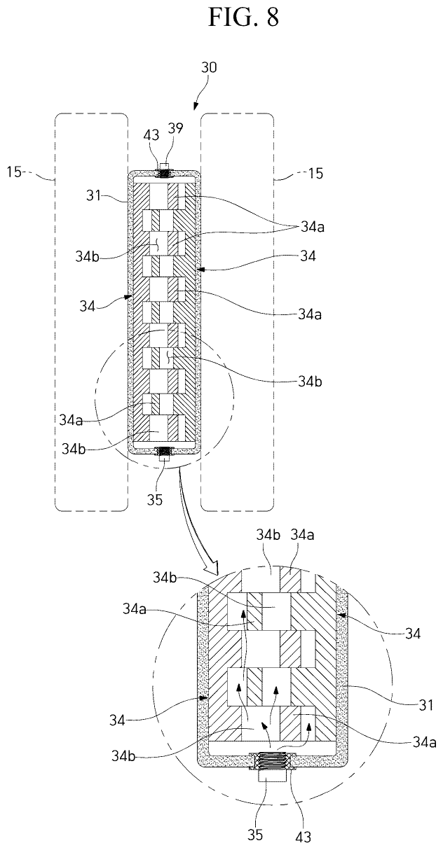

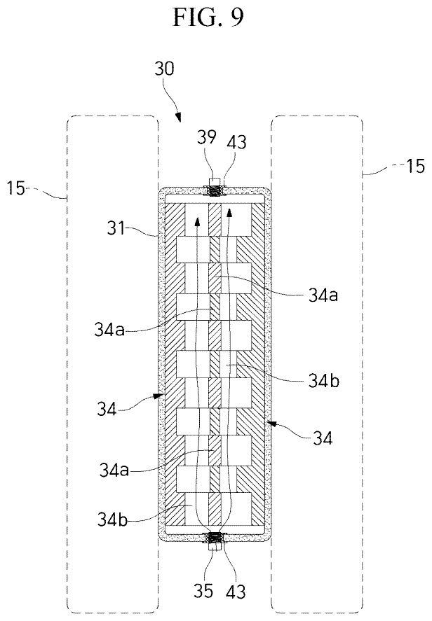

FIGS. 8 and 9 are views illustrating another modified example of the insulation unit of FIG. 5. FIG. 8 illustrates a state in which the insulation unit 30 is pressed by the battery cells 15 and shrinks. FIG. 9 illustrates a state in which the insulation unit 30 is expanded by a filler.

Referring to the drawings, a pair of pressing plates 34 may be installed inside the variable housing 31. The pressing plates 34 may have a different structure from the pressing plates 33 illustrated in FIG. 5.

The pressing plates 34 installed in the insulation unit 30 of FIGS. 8 and 9 may face one another inside the variable housing 31 and may have a plurality of cross-protrusions 34a on surfaces facing one another. The cross-protrusions 34a are portions that protrude toward the facing pressing plates 34 and may have a predetermined thickness and distance. In addition, a guide passage 34b may be formed in the cross-protrusions 34a. The guide passage 34b is a hole through which the filler to be injected or the filler to be discharged may pass.

The cross-protrusions 34a may be in surface contact with one another in a crossing state and may slide when the variable housing expands and shrinks. That is, the cross-protrusions 34a slide when the pressing plates 34 at both sides of the insulation unit 30 move away from or toward one another. By utilizing the cross-protrusions 34a, the distortion of the pressing plates 34 at both sides of the insulation unit 30 can be prevented. For example, the left and right pressing plates 34 can be prevented from being misaligned vertically.

FIGS. 10 and 11 are views for describing a configuration and operation of the injection port 35 as a filler passage applicable to the insulation unit 30 according to some embodiments of the present disclosure.

The injection port 35 can function to guide the filler provided from the outside to the inside of the variable housing 31. The filler may be press-fitted into the variable housing 31 through the injection port 35. In addition, the filler injected into the variable housing 31 is not discharged through the injection port.

The injection port 35 may include a body 35a, a shutter 35f, and a torsion hinge 35g. The body 35a is a cylindrical member having a passage 35c in a central portion thereof and may be screw-coupled to the fixing nut 43. The passage 35c may be an injection port through which the filler passes. In addition, a male screw thread may be formed on an outer circumferential surface of the body 35a.

The shutter 35f may be provided on an upper portion of the body 35a to open and close the passage 35c. When the shutter 35f moves downward, the passage 35c is closed, and when the shutter 35f moves upward, the passage may be opened. The torsion hinge 35g is a member for connecting the body 35a to the shutter 35f and may elastically support the shutter 35f downward in a direction of the arrow h.

FIG. 10 illustrates a state in which an injection tube P approaches the passage 35c to inject the filler into the variable housing 31. When the injection tube P is fully inserted into the passage 35c and then moves further, the shutter 35f may be opened by being pushed by the injection tube as illustrated in FIG. 11. When the injection tube is removed after the filler is injected through the injection tube P in a state in which the shutter 35f is open, the shutter 35f may be automatically closed by the operation of the torsion hinge 35g.

FIGS. 12 and 13 are views for showing a configuration and operation of the vent port 39 as a filler passage applicable to the insulation unit 30 according to some embodiments of the present disclosure.

The vent port 39 may provide a passage through which the filler inside the variable housing is discharged to the outside of the variable housing when the battery cells at both sides of the insulation unit 30 expand. The vent port 39 may include a body 39a and a built-in spring 39f.

The body 39a may have a cylinder shape that is open on the bottom and may be screw-coupled to the fixing nut 43. The body 39a may be elastically deformed by an external force. For example, when the pressure of the variable housing 31 increases, a close-contact passage 39b may be spread and opened. The body 39a may be formed of heat-resistant rubber or silicone.

A receiving space 39c and the close-contact passage 39b may be formed in the body 39a. The receiving space 39c is a space that is open on the bottom and may receive the internal pressure of the variable housing 31. A pressing surface 39d may be formed above the receiving space 39c. The pressing surface 39d may be a pressing surface pressed by the filler.

The close-contact passage 39b is a microscopic passage that opens the receiving space 39c upward. The close-contact passage 39b may shrink and may be closed when no external force is applied to the body 39a and may be spread by the pressing force generated when the filler presses the pressing surface 39d. FIG. 12 illustrates a state in which the close-contact passage 39b is closed. FIG. 13 illustrates a state in which the close-contact passage 39b is open.

When the close-contact passage 39b is open, the filler may be discharged and the variable housing 31 may shrink. In addition, when the pressure of the filler decreases, the close-contact passage 39b is re-closed.

The built-in spring 39f may be a leaf spring that is built on top of the body 39a and may provide an elastic force to the body 39a. The close-contact passage 39b may maintain the shrunk state more stably by the elastic force of the built-in spring 39f.

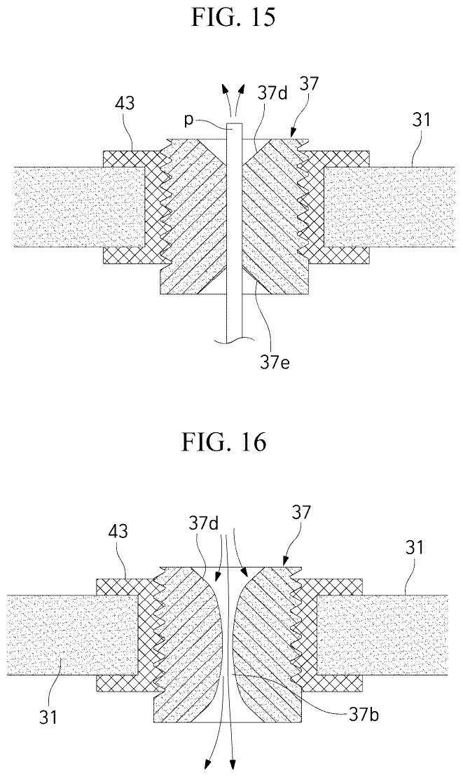

FIGS. 14 to 16 are views for showing a configuration and operation of the two-way port 37 as a filler passage applicable to the insulation unit 30 according to some embodiments of the present disclosure. FIG. 14 illustrates a state in which the two-way port 37 is completely closed. FIG. 15 illustrates a state in which the injection tube P is inserted into the two-way port 37. In addition, FIG. 16 illustrates a state in which the filler is vented through the two-way port 37. The two-way port 37 may be used as a passage through which the filler is injected into the variable housing 31 or the filler is discharged.

The two-way port 37 may be formed of heat-resistant rubber or silicone and elastically deformed by an external force. That is, the two-way port 37 is pressed and opened when the internal pressure of the variable housing 31 increases or spreads when the injection tube P is inserted. The two-way port 37 may have an integrated structure and may be screw-coupled to the fixing nut 43.

The close-contact passage 37b may be formed on a central axis portion of the two-way port 37, the pressing surface 37d may be formed on an upper portion of the close-contact passage 37b, and a guide surface 37e may be formed on a lower portion thereof.

The close-contact passage 37b is a gap formed on the central axis portion of the two-way port 37 and may be spread by an external force. The close-contact passage 37b may be a hole through which the filler inside the variable housing 31 is discharged or a passage through which the injection tube P passes. The close-contact passage 37b may be closed in a shrunk state when no external force is applied and spread when an external force is applied.

The pressing surface 37d is an inclined surface pressed by the filler injected into the variable housing 31. The filler may press the pressing surface 37d and spread the close-contact passage 37b in a radial direction to be discharged externally. FIG. 16 illustrates a state in which the filler is discharged externally through the close-contact passage 37b. When the internal pressure of the variable housing 31 is smaller than the shrinking strength of the close-contact passage 37b, the filler is not vented.

The guide surface 37e is an inclined surface that guides the injection tube P to the close-contact passage 37b. A front end portion of the injection tube P may be guided by the guide surface 37e and then inserted into the close-contact passage 37b. As illustrated in FIG. 15, the filler may be press-fitted into the variable housing 31 while the injection tube P is inserted into the two-way port 37.

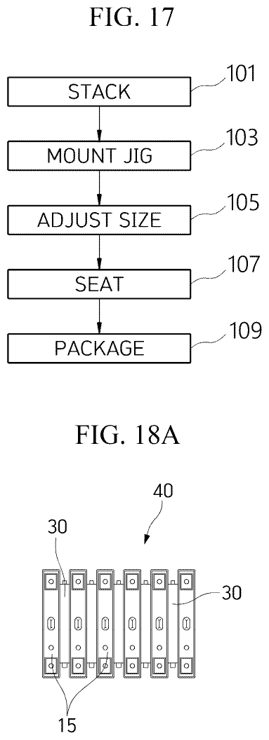

FIG. 17 is a flowchart for showing a method of manufacturing a secondary battery module according to some embodiments of the present disclosure. FIGS. 18A-18E are schematic views illustrating the method of manufacturing a secondary battery module according to some embodiments of the present disclosure.

As illustrated, the method for manufacturing a secondary battery module according to the present embodiments may include a stacking operation 101, a jig mounting operation 103, a size adjusting operation 105, a seating operation 107, and a packaging operation 109.

The stacking operation 101 is a process of forming the stack 40 to be seated inside the module case 57 (see e.g., FIG. 18A). The stack 40 may be composed of the plurality of battery cells 15 and the insulation unit 30. The insulation unit 30 may be inserted between the battery cells 15 to suppress heat transfer between the battery cells and maintain an electrically insulated state. The thickness of the insulation unit 30 may be adjusted by injecting or venting a filler.

The jig mounting operation 103 is a process of arranging jigs (see e.g., FIG. 18B) outside outermost battery cells 15 of the stack 40 that has completed the stacking operation 101. The jigs 51 may be disposed at opposite sides with the stack 40 interposed therebetween. A distance L2 between the jigs 51 facing one another is equal to an internal length S of the module case 57.

In addition, a height L1 of the stack 40 may be greater than or smaller than the distance L2 of the jigs 51. In the present description, the “height of the stack” is a distance between outer surfaces of the outermost battery cells 15. The height of the stack may vary depending on the thickness distribution of the battery cells 15. That is, the height of the stack may be greater than or smaller than the distance L2. FIG. 18B illustrates a case in which the height L1 of the stack is smaller than the distance L2.

The size adjusting operation 105 is a process of adjusting the thickness of the insulation unit 30 to match the total thickness of the stack 40, that is, the height (L1), with the length S of the internal space of the module case.

That is, as illustrated in FIG. 18B, the size adjusting operation 105 is a process of injecting a filler into the variable housing 31 to increase the height L1 and adjust the outermost battery cells 15 to be in close contact with the jigs 51 when the height L1 of the stack is smaller than the distance L2 between the jigs 51.

In addition, the size adjusting operation 105 is a process of further increasing the distance between the jigs to accommodate the stack 40 when the height L1 of the formed stack 40 is greater than the distance L2 of the jigs and then decreasing the distance between the jigs 51 to match the distance between the jigs to L2. In this configuration, the filler inside the variable housing 31 is vented from the variable housing 31. Reference numeral 55 of FIG. 18C is a dispenser for injecting the filler into the insulation unit 30.

The seating operation 107 is a process of installing the stack 40 whose size adjustment is completed into the module case 57. Through the size adjusting operation 105, the height of the stack 40 matches the length S of the module case 57, and thus the stack 40 can be tightly mounted inside the module case 57.

The packaging operation 109 is a process of packaging the module case after the seating operation 107 is completed. During the packaging operation 109, wiring, a busbar, etc. for electrically connecting the battery cells 15 to an external device may be mounted. The manufacturing of the secondary battery module may be completed through the packaging operation 109.

A secondary battery module of the present disclosure having the above configurations can adjust a gap between cells to cancel thickness distribution even when thickness distribution of the cells forming a secondary battery module occurs, thereby securing a constant length of a cell stack and preventing pressing defects in a process of manufacturing a module.

Although the present disclosure has been described herein with respect to embodiments thereof, the present disclosure is not limited thereto. Various modifications and variations can be made thereto by those skilled in the art within the spirit of the present disclosure.

What is claimed is:

1. A secondary battery module comprising:
a module case that provides an internal space;
a plurality of battery cells disposed in the module case; and
a plurality of insulation units that are interposed between the plurality of battery cells and maintain a distance between the plurality of battery cells,
wherein each of the plurality of insulation units comprises:
a variable housing that accommodates a filler injected from an outside region and is configured to expand due to a pressure of the filler to increase the distance between the plurality of battery cells or to shrink by receiving a pressure of the plurality of battery cells; and
a filler passage provided at one side of the variable housing to allow the filler to pass therethrough.

2. The secondary battery module as claimed in claim 1, wherein a plurality of pressing plates, which move away from one another and transfer the pressure to the plurality of battery cells as an internal pressure of the variable housing increases, are installed inside the variable housing.

3. The secondary battery module as claimed in claim 2, wherein the variable housing is configured to melt due to heat generated inside the module case and rupture due to an action of the internal pressure of the variable housing.

4. The secondary battery module as claimed in claim 3, wherein a through hole, which allows the filler inside the variable housing to pass therethrough when the variable housing ruptures, is formed in the plurality of pressing plates.

5. The secondary battery module as claimed in claim 4, wherein the plurality of pressing plates face one another in the variable housing, and
wherein a plurality of cross-protrusions, which are in surface contact with one another in a crossing state and slide when the variable housing expands and shrinks, are further formed on surfaces facing one another of the plurality of pressing plates.

6. The secondary battery module as claimed in claim 1, wherein the filler passage comprises an injection port that guides the filler provided from the outside region to inside of the variable housing.

7. The secondary battery module as claimed in claim 6, wherein the filler passage further comprises a vent port that discharges the filler inside the variable housing to the outside region of the variable housing when a battery cell of the plurality of battery cells expands.

8. The secondary battery module as claimed in claim 1, wherein the filler passage comprises a two-way port that guides the filler provided from the outside region to inside of the variable housing and discharges the filler inside the variable housing to the outside region of the variable housing when a battery cell of the plurality of battery cells expands.

9. The secondary battery module as claimed in claim 1, wherein the filler comprises at least one of air, an aerofoam, and an extinguishing agent.

10. A method of manufacturing a secondary battery module, comprising:
a stacking operation of stacking an insulation unit that suppresses heat transfer between a plurality of battery cells to be accommodated inside a module case and that allows a thickness thereof to be adjusted, wherein the insulation unit is stacked to be interposed between adjacent battery cells;
a jig mounting operation of arranging a jig outside an outermost battery cell of a stack;
a size adjusting operation of adjusting the thickness of the insulation unit and matching a total thickness of the stack with a length of an internal space of the module case;
a seating operation of installing the stack whose size adjustment is completed in the module case; and
a packaging operation of packaging the module case.

11. The method as claimed in claim 10, wherein the insulation unit accommodates a filler injected from the outside and is configured to expand due to a pressure of the filler to increase a distance between the battery cells or to shrink by receiving a pressure of the battery cells, and
wherein the size adjusting operation is a process of press-fitting the filler into the insulation unit to increase the total thickness of the stack or pressing the stack using a jig to decrease the total thickness.

12. An insulation unit for a secondary battery module, comprising:
a variable housing that accommodates a filler injected from an outside region and is configured to expand due to a pressure of the filler to increase a distance between a plurality of battery cells or to shrink by receiving a pressure of the battery cells after being interposed between the plurality of battery cells to be mounted in a module case for a secondary battery module; and
a filler passage provided at one side of the variable housing to allow the filler to pass therethrough.

13. The insulation unit as claimed in claim 12, wherein a plurality of pressing plates, which move away from one another and transfer the pressure to the battery cells as an internal pressure of the variable housing increases, are installed inside the variable housing.

14. The insulation unit as claimed in claim 13, wherein the variable housing is configured to melt due to heat generated inside the module case and rupture due to an action of the internal pressure of the variable housing.

15. The insulation unit as claimed in claim 14, wherein a through hole, which allows the filler inside the variable housing to pass therethrough when the variable housing ruptures, is formed in the plurality of pressing plates.

16. The insulation unit as claimed in claim 15, wherein the plurality of pressing plates face one another in the variable housing, and
wherein a plurality of cross-protrusions, which are in surface contact with one another in a crossing state and slide when the variable housing expands and shrinks, are further formed on surfaces facing one another of the plurality of pressing plates.

17. The insulation unit as claimed in claim 12, wherein the filler passage comprises an injection port that guides the filler provided from the outside region to inside of the variable housing.

18. The insulation unit as claimed in claim 17, wherein the filler passage further comprises a vent port that discharges the filler inside the variable housing to the outside region of the variable housing when a battery cell of the plurality of battery cells expands.

19. The insulation unit as claimed in claim 12, wherein the filler passage comprises a two-way port that guides the filler provided from the outside region to inside of the variable housing and discharges the filler inside the variable housing to the outside region of the variable housing when a battery cell of the plurality of battery cells expands.

20. The insulation unit as claimed in claim 12, wherein the filler comprises at least one of air, an aerofoam, and an extinguishing agent.
